(19) United States
(12) Patent Application Publication
(10) Pub. No.: US 2011/0174327 A1
(43) Pub. Date: Jul. 21, 2011

(54) Gem tip

(75) Inventor: Roberta Beatrice KoehI, Hidden Hills, CA (US)

(73) Assignee: KoehI Enterprises, Inc., Hidden Hills, CA (US)

(21) Appl. No.: 12/460,024

(22) Filed: Jul. 13, 2009

(51) Int. Cl. B08B 1/00

(52) U.S. Cl. 132/200; 15/118

(57) ABSTRACT

A unique device that has two sides, one gauze, one cotton, to allow the cleaning and exfoliating of skin in delicate areas, and normal surface areas where delicacy is unnecessary. The device can clean makeup, exfoliate, clean wounds, be used on delicate surfaces and in hart-to reach areas while changing surfaces dependent on applicator used. It can remove makeup around the eye and perform all functions normally serviced by a tip applicator with a stronger secondary surface that increases the number of uses, and makes the item in issue long lasting for comparable price. The cotton is absorbent, while the gauze side is strong enough to remove all dirt without deteriorating, and do so faster and more efficiently than cotton alone. It is essentially a potentially two-step device, the delicate side for usage first, followed by the stronger gauze covering as deemed necessary. There is no comparable prior or present art.

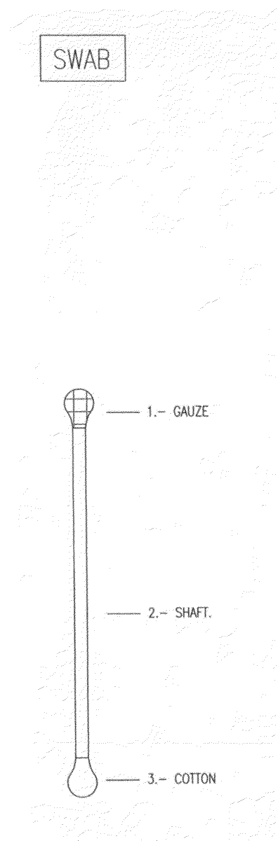

The invention in issue is the companion device to the utility pad filing under application Ser. No. 12/427,557, filed Apr. 21, 2009. The Unique features here are the two-sided, different sided applications. The pad has gauze on one-side, and cotton on the other, making it unique in the industry. The reviewer should analyze that patent application in conjunction with this. However, the pad, now to be called the “Myriad Pad,” cannot effectively reach certain delicate body surfaces and areas around the eye, or between the feet, due its unwieldy nature and comparatively larger size. Hence, the two-sided tip cleaning device. The premise is identical, from the same inventor.

### BACKGROUND OF INVENTION

1. The Invention Itself

One presents a two-sided cardboard based applicator, with gauze on one side, and cotton on the other. The two different sides serve two different functions. The cotton is soft, and can deal with delicate areas, as any normal cotton applicator or swab. But the gauze side can deal with heavier problems, stubborn makeup, heavy dirt, etc., where cotton has no real value due to its softness and lack of durability. The device is marginally more expensive than that on the market, but will be competitive. Hence, the name “Gem Tip.”

2. Description of the Prior are

There is no prior art comparable to the proposed inventions here. The “Q-Tip” is not competitive. Said tip is a double-sided cotton swab, and has no gauze or stronger surface. It is roughly similar in size, but cannot serve the functions of the “Gem Tip.” The basis for the Gem Tip is unrelated to the Q-Tip; the basis is the companion patent pending pad, not the Q-Tip. Outside of the Q-Tip, or its generic companions, there is no competition extant. There is no dual purpose item or product on the market at this time.

### SUMMARY OF THE INVENTION

The multiple objectives of the invention are best described by the abstract that follows. They are accompanied by drawings that detail the construction of the tip, and how the product may be used by the end consumer.

The objectives of the invention are multiple:
1. To create a dual purpose cleaning utensil that can both clean and exfoliate delicate areas and harsher surfaces, without the need for additional chemicals or devices, presently unknown on the market;
2. A device that is competitive in cost with the present market, but is more durable, has additional features, is safe to use, and is biodegradable;
3. To produce a companion invention to the mentioned utility pad above, so an end-user may have the ability to serve all bodily needs, regardless of surface or difficulty of function.

### BRIEF DESCRIPTION OF THE DRAWINGS

The drawing is self-explanatory, and connection to the physical structure of the device. The drawing is a view of the swab.

### DESCRIPTION OF THE PREFERRED EMBODIMENTS

There are obvious nuances here. One can't be certain of all the users of this device at this time. No one has ever produced a two-sided invention with multiple surfaces. The gauze over absorbent cotton (1) makes this swab a better cleaning device. The cotton (2) at one end and the gauze (1) at the other end enhances its functionality. It may have uses in industry, with piping, and other facets presently unknown, due to the gauze side. But the application here is cosmetic and bodily cleansing. Industry usage may vary, and those uses will become evident after the product is in service.

What is claimed is:

1. A unique two-sided gauze and cotton tipped device, with one side being cotton, and the other side being gauze, in a disposable format for use in the cars and around the face. The device in issue has no comparable prior art; all prior art is two-sided in cotton alone.

2. A unique device, by which an end user can have a soft permeable surface and a rougher more exfoliant surface to handle different needs of the ears and the surfaces around the eyes. The soft cotton side can clean gentle surfaces, such as the interior ear, and the gauze side of the tip can deal safely with dirt, makeup, and skin conditions where a stronger surface is needed and can be safely used.

3. A method of cosmetic treatment that allows more than one usage of a cleaning tip, predicated on the duality of the surfaces. All other present art is limited by cotton coverings, and cannot service the more difficult functions, such as removal of dirt, and stubborn makeup.

4-7. (canceled)

8. The invention cleans the skin surface, can exfoliate the same, can clean a wound, and remove nail polish and makeup. Both sides are absorbent, and the gauze side can condition the skin in ways cotton cannot. In addition, the gauze side removes polish and makeup faster and more efficiently than cotton.
